(19) United States
(12) Patent Application Publication
(10) Pub. No.: US 2011/0227446 A1
(43) Pub. Date: Sep. 22, 2011

(54) Stator for rotary electric machine and method for making same

(75) Inventor: Bertrand Vedy, La Tour de Peilz (CH)

(73) Assignees: SOCIETE DE TECHNOLOGIE MICHELIN, Clermont-Ferrand (FR); Michelin Recherche et Technique S.A., Granges-Paccot (CH)

(21) Appl. No.: 13/062,211

(22) PCT Filed: Aug. 31, 2009
(86) PCT No.: PCT/EP2009/061216

§ 371 Date: May 23, 2011

(30) Foreign Application Priority Data
Sep. 3, 2008 (FR) 0855896

(51) Int. Cl. H02K 1/18; H02K 15/02

(52) U.S. Cl. 310/216.118; 29/596

(57) ABSTRACT

An external stator for an electrical rotating machine, the stator including a substantially cylindrical sheath and a laminated magnetic circuit, said magnetic circuit comprising a first stack of yoke metal sheets arranged perpendicularly to the axis of the stator, the first stack forming an external covering for the magnetic circuit; and a second stack of star-shaped metal sheets arranged perpendicularly to the axis inside said external covering, the star-shaped sheets being made integral with said external covering; wherein the stack of yoke metal sheets is held in the sheath between a first axial stop integral with the sheath and a clamping washer, the clamping washer being shrink-fitted into the sheath.

The present invention relates to electrical rotating machines, and more particularly to the external stator of electrical machines whose rotor is placed inside the stator.

The stator principally comprises a magnetic circuit and windings of electrically conductive wires. The magnetic circuit, for its part, is always laminated; it is formed by a stack of magnetic metal sheets. Each metal sheet is cut in such a way as to create slots separated by teeth, the slots being the housing of the electrically conductive wires, in general made of insulated copper wire, often round in section. Each slot is delimited by two substantially radially oriented walls and a slot base and includes an opening. This principle of arranging the stator is widely applied to synchronous or asynchronous machines.

Patent application EP 1174988 discloses electrical machines in which the stator magnetic circuit is made in two parts: an internal part comprising the slots and an external part surrounding the slots. The magnetic circuit is laminated and is manufactured from ferromagnetic metal sheets for reasons well known to a person skilled in the art. In this type of magnetic circuit, each tooth separating two slots does not form a continuous piece with the external part of the magnetic circuit. Thanks to this arrangement, it is possible to form a core comprising the internal part of the magnetic circuit, on which the conductive wires can be wound in the slots, with access to the slots being from the outside. Then, the internal part is covered by the external part to complete the magnetic circuit. This magnetic circuit in two parts is integral with a sheath which surrounds it and holds it mechanically. The sheath may further have the function of containing a cooling liquid. Patent document EP 1174988 also discloses a method of assembling the stator consisting in first fixing the external part of the stator in the sheath, then placing the internal part in the external part before gluing the assembly together through the intermediary of a resin.

One difficulty in obtaining this type of magnetic circuit in two parts concerns the assembly and holding in place of the metal sheets of the external part. This is because the assembly disclosed in document EP 1174988 is relatively complicated to make, which hinders its use in industrial mass production.

One object of the invention is therefore to provide an improved electrical machine, notably regarding the assembly of the stator magnetic circuit.

For this the invention provides an external stator for an electrical rotating machine, the stator including a substantially cylindrical sheath and a laminated magnetic circuit, said magnetic circuit comprising:
a first stack of yoke metal sheets arranged perpendicularly to the axis of the stator, the first stack forming an external covering for the magnetic circuit;
a second stack of star-shaped metal sheets arranged perpendicularly to the axis inside said external covering, the star-shaped sheets being made integral with said external covering;
   in which the stack of yoke metal sheets is held in the sheath between a first axial stop integral with the sheath and a clamping washer, the stator being characterized in that the clamping washer is shrink-fitted into the sheath, supported against a second axial stop of the sheath.

Preferably, the clamping washer is made of a non-magnetic, dielectric material, preferably of a synthetic material.

Preferably, the synthetic material is PEEK.

Preferably, a support washer is inserted between the first stop and the stack of yoke metal sheets.

Preferably, the support washer is made of synthetic material, again preferably identical to the material of the clamping washer.

Preferably, the yoke metal sheets have at least one peripheral pin cooperating with at least one longitudinal groove of the sheath for immobilizing the sheets rotating with respect to the sheath.

Preferably, the yoke metal sheets have at least two peripheral pins diametrically opposite one another cooperating with at least two longitudinal grooves of the sheath.

The invention also relates to an electrical rotating machine comprising such a stator.

The invention further relates to a method of manufacturing such a stator, said method comprising stages consisting successively of:
cutting a plurality of yoke metal sheets,
stacking the yoke metal sheets in the sheath supported against a first axial stop integral with the sheath,
clamping the stack axially and,
immobilizing the stack through the intermediary of a shrink-fitted clamping washer against a second axial stop integral with the sheath.

Preferably, the yoke metal sheets are stacked head to tail.

The invention will be better understood thanks to the rest of the description, which is based on the following figures:

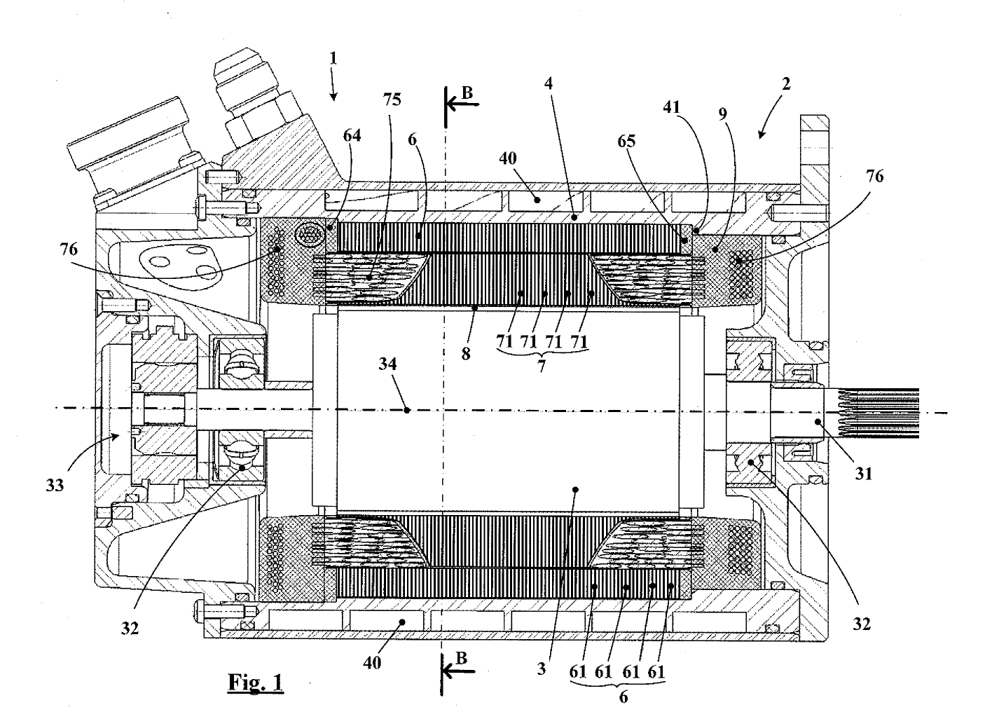

FIG. 1 is a sectional view along the axis of rotation of an electrical machine according to the invention (along the line A-A seen in FIG. 2),

FIG. 2 is a sectional view of the stator in a plane perpendicular to the axis (along the line B-B seen in FIG. 1),

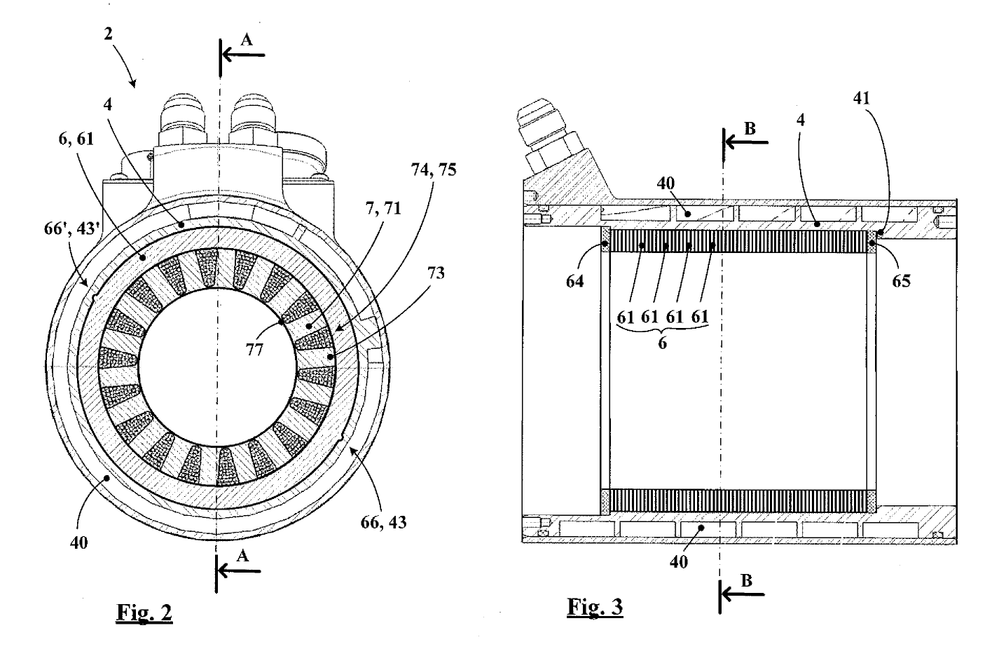

FIG. 3 is a similar view to FIG. 1, showing a part of the stator according to the invention,

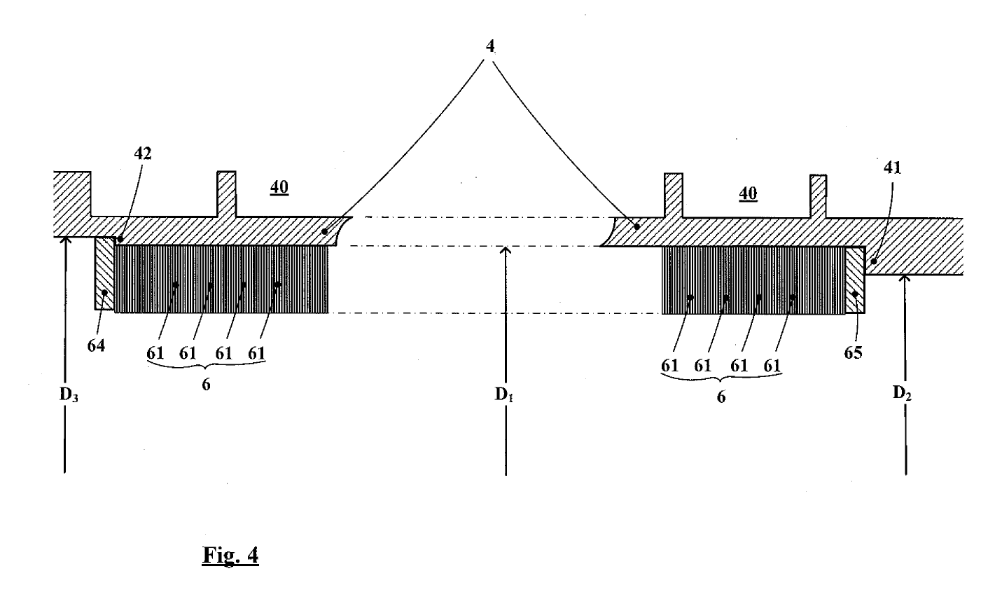

FIG. 4 is a schematic sectional view along the axis showing on a larger scale the detailed assembly of the stator magnetic circuit according to the invention.

FIG. 1 shows an electrical machine 1 comprising an external stator 2 and an internal rotor 3 separated by an air gap 8 of very small thickness, the figure being a section in a plane containing the axis of rotation 34 of the machine. The rotor 3 has a shaft 31 fitted by means of two bearings 32 inside the rotor. Also shown is an encoder/resolver 33 placed at one of the ends (left in FIG. 1) of the shaft. For further details on an example of a rotor that can be used in this type of electrical machine, the reader is invited to consult patent application EP 1359657 for example. This is, however, only a non-restrictive example of a rotor that may be associated with the stator provided by the present invention.

As can also be clearly seen in FIG. 2, the stator magnetic circuit is formed of two distinct parts. Each of these two parts is obtained by stacking a large number of metal sheets cut in a magnetic metal sheet and arranged substantially parallel to a plane perpendicular to the axis. The metal sheets may have a very small unit thickness, e.g. of the order of a few tenths of a millimetre, 0.2 mm for example.

A first stack 6 of yoke metal sheets 61 forms the external covering of the magnetic circuit. A second stack 7 of star-shaped metal sheets 71 is arranged inside the external covering. This second stack forms the teeth 73 which delimit the slots 74 containing the wires of the stator windings 75.

Unlike the generally accepted construction in which the slots are radially open towards the inside of the machine, the slot feet here are preferably closed by the magnetic circuit over the entire inside periphery of the stator. A very thin partition 77 on the radially inner side of the slot 74, less than 0.5 mm for example, and preferably less than 0.4 mm, is sufficient to give it great mechanical strength since the partition is continuous.

The electrically conductive wires arranged in the slots are embedded in an impregnating resin 9. In FIG. 1 it can be seen that the same resin coats the coil ends 76 at each end of the stator beyond the magnetic circuit.

The teeth 73 are thus made integral with the external covering by gluing. Gluing is only one advantageous embodiment. These two parts of the magnetic circuit may, however, be made integral with one another by any appropriate means.

The external covering 6 is fitted inside a sheath 4 which surrounds it and holds it mechanically. Furthermore a circuit 40 can be used for the circulation of a cooling fluid in the sheath (see also FIG. 1).

According to the invention, the external covering 6 is fitted inside the sheath 4 according to a particular assembly which will be disclosed with reference to FIGS. 3 and 4.

The stack 6 of yoke metal sheets 61 on the one hand is supported on a first axial stop integral with the sheath 4, here a first shoulder 41 (to the right on the figures). Preferably, a support washer 65 is inserted between said shoulder and the first metal sheet of the stack. At the other end of the stack, a clamping washer 64 holds the stack in place. According to the invention, the clamping washer is shrink-fitted into the sheath, i.e. its free diameter is larger than the inside diameter of the sheath (D₃) at this end.

Compared with fastening with the aid of a spring ring according to the state of the art, fastening by shrink-fitting according to the present invention has the advantage of facilitating the industrialization of the method of manufacturing and assembly of the stator since first it eliminates an operation of machining the groove and secondly it eliminates the tricky operation of fitting the spring ring in said groove while maintaining axial pressure on the stack of yoke metal sheets.

The clamping washer is supported against a second axial stop, here a second shoulder 42 of the sheath 4, so as to define a specified dimension for the length of the magnetic circuit, independently of the axial compression force applied to the stack. The assembly method is thus further simplified whilst ensuring excellent reproducibility.

The sheath then presents at least three characteristic diameters that may be defined in the following way:
a central diameter (D₁) in which the stack 6 is placed (as well as the support washer 65 where appropriate).
a support diameter (D₂) smaller than the central diameter (D₁) so as to define the first stop (here, the first shoulder 41).
a shrink-fitting diameter (D₃) into which the clamping washer is shrink-fitted.

The shrink-fitting diameter (D₃) is larger than the central diameter (D₁), these two diameters together defining the second stop (here, the second shoulder 42).

These three diameters must therefore comply with the following relationship: D₃>D₁>D₂.

In a way known per se, the clamping washer 64 must, to be shrink-fitted, present a free diameter larger than the shrink-fitting diameter (D₃). This difference in diameter is determined according to the axial force expected in operation, notably taking into account the manufacturing tolerances of each of the two elements to be assembled. In practice, the difference in diameter may be of the order of a few hundredths of a millimetre, less than 10 hundredths for example.

At the time of assembly, thermal expansion/retraction of the sheath 4 and the clamping washer 64 is used for pressing the washer towards its final position. There will therefore be a tendency to heat the sheath and/or cool the washer by several tens of degrees (° K). Also in a way known per se, the edges of the parts are preferably bevelled.

According to a preferred embodiment of the invention, the clamping washer is made of a synthetic, non-magnetic and good dielectric material. Polyetheretherketone is preferably chosen, commonly referred to by the abbreviation “PEEK”. One advantage of this material is that it can be used to create a shrink fitting whose pullout strength does not vary very much during thermal expansions of the sheath, the latter preferably being made of aluminium alloy.

Preferably, the yoke metal sheets 61 further include a first pin 66 capable of cooperating with a first groove 43 of the sheath for blocking any relative rotation of these two elements.

Advantageously, a second pin 66′, diametrically opposite the first pin 66, cooperates with a second groove 43′. In this way, the metal sheets can be stacked head to tail, i.e. rotated 180° with respect to one another during stacking. This rotation can be done around the axis of the stator or around an axis perpendicular to the axis of the stator. Thus, a possible variation in thickness from one side to the other of the sheets does not have any deleterious effect on the distribution of axial pressure exerted on the stack.

The invention also relates to a preferred method of manufacture of such a stator for an electrical rotating machine. The main stages in the method are as follows:
cutting yoke metal sheets 61 in an annular shape,
stacking yoke metal sheets so as to obtain an external covering 6,
locking the stack of yoke metal sheets in the sheath by shrink-fitting a clamping washer 64, and in addition,
cutting star-shaped metal sheets 71 having a circular base 77 and radiating teeth 73 protruding towards the outside and forming a single piece with the base,
stacking these star-shaped metal sheets on a sleeve so as to superpose the teeth and obtain a core having slots 74 between the teeth open towards the outside.
winding the conductive wires 75 in the slots,
   then,
assembling the core supporting the windings 75 and the external covering 6 and making them integral with one another, preferably through the intermediary of a resin 9 impregnating the wires.
removing the sleeve,
machining the bases if necessary so as to adjust the internal diameter of the stator.

The phase of impregnating the windings, well-known per se to a person skilled in the art, here therefore fulfils an additional function: it makes the star-shaped metal sheets 71 (and therefore the teeth 73) and the yoke metal sheets 61 integral. Preferably, the impregnation also glues the magnetic circuit in the sheath 4.

Electrical machines according to the invention can be used both as electric motors or as alternators (generators).

1. An external stator for electrical rotating machine, the stator including a substantially cylindrical sheath and a laminated magnetic circuit, said magnetic circuit comprising:
a first stack of yoke metal sheets arranged perpendicularly to the axis of the stator, the first stack forming an external covering for the magnetic circuit; and
a second stack of star-shaped metal sheets arranged perpendicularly to the axis inside said external covering, the star-shaped sheets being made integral with said external covering;
wherein the stack of yoke metal sheets is held in the sheath between a first axial stop integral with the sheath and a clamping washer, the clamping washer is being shrink-fitted into the sheath, supported against a second axial stop of the sheath.

2. The stator according to claim 1, wherein the clamping washer is made of a non-magnetic, dielectric material.

3. The stator according to claim 2, wherein the clamping washer is made of synthetic material.

4. The stator according to claim 3, wherein the synthetic material is PEEK.

5. The stator according to claim 1, wherein a support washer is inserted between the first stop and the stack of yoke metal sheets.

6. The stator according to claim 5, wherein the support washer is made of synthetic material.

7. The stator according to claim 5, wherein the material of the support washer is identical to the material of the clamping washer.

8. The stator according to claim 1, wherein the yoke metal sheets have at least one peripheral pin cooperating with at least one longitudinal groove of the sheath for immobilizing the sheets rotating with respect to the sheath.

9. The stator according to claim 8, wherein the yoke metal sheets have at least two peripheral pins diametrically opposite one another cooperating with at least two longitudinal grooves of the sheath.

10. An electrical rotating machine including a stator according to claim 1.

11. A method of manufacturing a stator according to claim 1, comprising the steps of:
cutting a plurality of yoke metal sheets;
stacking the yoke metal sheets in the sheath supported against a first axial stop integral with the sheath;
clamping the stack axially; and
immobilizing the stack through the intermediary of a shrink-fitted clamping washer against a second axial stop integral with the sheath.

12. The method according to claim 11, wherein the yoke metal sheets are stacked head to tail.
